(19) United States
(12) Patent Application Publication
(10) Pub. No.: US 2016/0011119 A1
(43) Pub. Date: Jan. 14, 2016

(54) Method And Apparatus For Characterising A Diffracting Surface

(71) Applicant: COMMISSARIAT A L'ENERGIE ATOMIQUE ET AUX ENERGIES ALTERNATIVES, Paris (FR)

(72) Inventors: Olivier Dellea, La Talaudiere (FR); Simon-Frédéric Desage, Saint-Chamond (FR); Pascal Fugier, Bernin (FR)

(21) Appl. No.: 14/770,981

(22) PCT Filed: Feb. 26, 2014
(86) PCT No.: PCT/IB2014/059267

§ 371 Date: Aug. 27, 2015

(30) Foreign Application Priority Data
Mar. 1, 2013 (FR) 13 51870

(51) Int. Cl. G01N 21/84; G06K 9/46; G06T 7/60; G06K 9/20

(52) U.S. Cl. CPC G01N 21/8422; G06K 9/2027; G06K 9/4661; G06T 7/608; G01N 2201/12; G01N 2201/061

(57) ABSTRACT

A method for characterizing a diffracting surface having a structure made of crystalline grain is provided. The method includes the steps of: a) sequentially illuminating the surface with a plurality of light beams (Fi) having propagation directions that are angled at a same angle Θ relative to the normal of the surface and the projections, onto the surface, of which form different azimuth angles ψi relative to a reference direction; b) acquiring an image of the surface corresponding to each of the light beams; and c) digitally processing the images such as to obtain information on at least one property of the surface selected among: the grain structure, the texture and the sequencing rate thereof. The invention also relates to an optical head and to an apparatus for implementing such a method.

The invention relates to a method for characterizing a diffracting surface having a grain structure, and to an apparatus for implementing this method and to an optical head of said apparatus. The invention in particular applies to the characterization and monitoring of the manufacture of assemblies of particles of nanoscale or micron-size dimensions on a substrate.

The order of compact assemblies of colloidal particles is important in a wide variety of applications: photonic crystals, SERS (surface-enhanced Raman scattering) sensors, biological sensors, etc.

At the present time, the order of diffracting structures, such as compact assemblies of colloidal particles, may be measured only using optical-type microscopy techniques or a scanning electron microscope. These techniques are not suitable for the characterization of structures occupying large areas (several centimeters square or more).

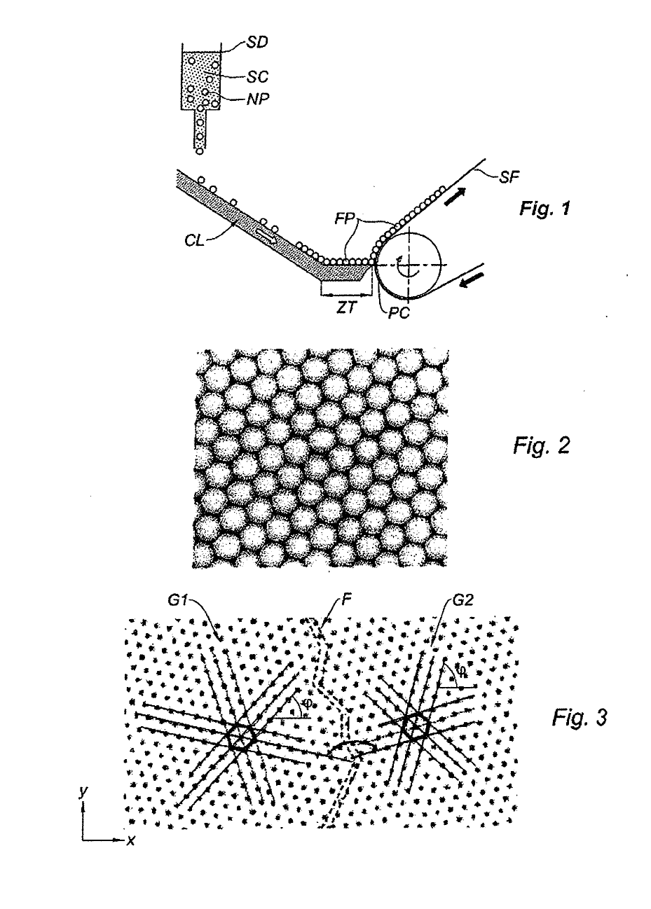

The Applicant has developed a process allowing compact films of micron-size or nanoscale particles to be transferred to flexible or rigid substrates. Such a process is described in document WO2012113745 and illustrated by FIG. 1, in which may be seen:
a system SD allowing particles NP dispersed in a liquid in order to form a suspension SC to be dispensed;
a liquid conveyor CL, formed by a flow of a “carrier” liquid, which may be different from that in which the particles NP are dispersed, for transporting and arranging the particles in order to form a compact film FP. This liquid conveyor flows over an inclined plane then through a horizontal zone called the transfer zone ZT; and
a flexible substrate SF made to move by a conveyor to which the compact film of particles must be transferred. The link between the liquid carrier and the substrate is ensured by a capillary bridge PC.

The process therefore consists in dispensing the particles onto the surface of the carrier liquid. The carrier liquid transports the particles as far as the transfer zone. The particles accumulate in the transfer zone, then also in the lower portion of the inclined plane. The particles present on the inclined plane then exert a pressure that helps order the particles present in the transfer zone. A variant of the process allows a rigid substrate to be used.

FIG. 2 shows a micrograph of a film of silica microspheres (diameter: 1.1 μm) deposited on a silicon substrate. It may be seen that the particles organize into a compact hexagonal configuration in which each particle is surrounded by 6 neighbors the centers of which form a hexagon.

In practice, the films of particles produced are made up of “grains” that comprise particles forming a regular lattice of hexagonal unit cells the orientation of which in the plane is specific. The grains differ from one another in the orientation of the elementary unit cell of their lattice. The size of the grains may vary from a few μm² (microns square) to as much as 1 cm² (centimeter square) or more; it depends on the size dispersion of the particles and on the parameters of the process (surface pressure, draw rate, activation of the particles, etc.). FIG. 3 shows two grains, G1 and G2, separated by a is boundary F. It will furthermore be noted that the grains do not necessarily have a perfectly periodic structure, but are characterized by a variable degree of order, which may be expressed by a number comprised between 0 (completely irregular amorphous arrangement) and 1 (perfectly periodic or “crystalline” arrangement).

When the constituent particles of such a film have suitable dimensions (in the case of spherical particles of silica on a liquid conveyor formed by water, a diameter comprised between about 500 nm and 2.5 μm), it is possible to observe light diffraction effects. The grain structure of the film then results in iridescence forming a random pattern.

The invention aims to provide a method allowing a compact film of micron-sized or nanoscale particles—or more generally a diffracting surface—to be characterized by validation of its structure (related to the shape of the grains), its texture (related to the orientation of the elementary unit cell of each grain) and/or its degree of order. The degree of order is defined as the ratio of the area of regions having a desired orientation to the total observed area.

According to the invention, such an aim is achieved by a method for characterizing a diffracting surface having a “crystal” grain structure, comprising steps consisting in:

a) illuminating in succession said surface with a plurality of light beams having propagation directions inclined at the same angle θᵢ to the normal to the surface and the projections of which onto the surface make different azimuthal angles φᵢ^{j} to a reference direction;

b) acquiring an image of said surface in correspondence with each of said light beams; and

c) digitally processing said images to obtain at least one piece of information on at least one property of said surface, chosen from: its grain structure, its texture and its degree of order.

According to various embodiments of this method:
Each of said grains may have a two-dimensional periodicity with hexagonal symmetry and said azimuthal angles φᵢ^{j} may be given by: φᵢ^{j}=φ₀+j·(60°/N), where N is the number of beams, the index j ranges from 1 to N and φ₀ is a constant. In “φφᵢ^{j}” the exponent “i” is not an index but indicates that it is a question of the azimuthal angle of an incident beam.
The number N of light rays used may, in particular, be higher than or equal to 3, and preferably higher than or equal to 6, and for example be comprised between 3 and 24 and preferably between 6 and 12.
In said step b), said images may be acquired in an observation direction normal to the surface to be characterized.
Said step c) may comprise the substeps consisting in:

c1) thresholding each of said images in order to attribute to each of its pixels a binary value indicative of a light intensity respectively higher than or lower than a set threshold;

c2) for each image having undergone said thresholding, calculating a proportion P of pixels having the same said binary value;

c3) determining the difference A between the highest value and the lowest value of the proportions P for said images; and

c4) if the value of A is comprised between a first threshold Aₘᵢₙ and a second threshold Aₘₐₓ, and if a stop condition is not met, subdividing each image into a plurality of smaller images corresponding to respective regions of the surface to be characterized, grouping the n smaller images corresponding to each of said regions and repeating the substeps c1) to c4) for each group thus obtained;

whereby a value A is attributed to the surface or to each of said regions of the surface.
Said proportion P of pixels having the same binary light intensity value may be expressed by a number comprised between 0 and 1, said first threshold Aₘᵢₙ may be comprised between 0.1 and 0.4, and said second threshold Aₘₐₓ may be comprised between 0.6 and 0.95.
In said substep c4), each image may be subdivided into four smaller images taking the form of quadrants. In this case, said image may advantageously be formed by a square matrix of pixels having a number of rows and columns that is a power of two.
The method may also comprise a step d) implemented after said step c) and consisting in identifying as crystal grains zones of the surface to be characterized formed by contiguous regions associated with subimages to which a value A>Aₘᵢₙ has been attributed and separated by contiguous regions associated with subimages to which a value A≦Aₘᵢₙ has been attributed. This provides information on the structure of the surface.
The method may also comprise a step e) implemented after said step c) and consisting in determining information on the texture of at least one of said regions of the surface to be characterized to which a value A>Aₘᵢₙ has been attributed, said step e) being implemented by identifying the azimuthal angle φᵢ^{j} to which corresponds the highest proportion of pixels having a light intensity higher than said set threshold. This provides information on the texture of the surface.
The method may also comprise a step f) implemented after said step c) and consisting in determining a degree of order ORD of the surface to be characterized by applying the formula ORD=1−(S_{NC}/S_{TOT}), where S_{NC} is the area of the regions of said surface to which a value A≦Aₘᵢₙ has been attributed and S_{TOT} is the total area of the observed portion of the surface.
Said surface to be characterized may especially be formed by an assembly of particles of nanoscale or micron-size dimensions on a substrate.

Another subject of the invention is the application of such a method to the monitoring of a process for manufacturing an assembly of particles of nanoscale or micron-size dimensions. The method according to the invention may be used to characterize the assembly deposited on a substrate, resulting from the manufacturing process, or indeed to carry out inline monitoring of said manufacturing process, by characterizing the assembly in a piece of equipment of the type in FIG. 1 before its deposition.

Yet another subject of the invention is an optical head for implementing such a method, comprising:
a transparent part having an axis of symmetry and comprising: a first array of M reflective facets arranged around said axis and the normals of which make an angle of about 45° to the latter; and a second array of M reflective facets arranged around said axis and said first array and the normals of which make the same angle larger than 45° to said axis, each facet of said second array being placed facing a respective facet of said first array; and a means for selectively illuminating each facet of said first array with a light beam propagating in a direction parallel to said axis of symmetry.

Said means for selectively illuminating each facet of said first array with a light beam propagating in a direction parallel to said axis of symmetry may in particular comprise: a light source, for directing toward said part a light beam propagating parallel to said axis of symmetry; an optical mask interposed between said light source and said part, said mask being mounted so as to be rotatable about said axis of symmetry and comprising an aperture in correspondence with a facet of said first array; and an actuator for making said optical mask rotate about said axis of symmetry.

Yet another subject of the invention is an apparatus for implementing such a method, comprising:
an optical head such as described above;
a camera mounted on that side of said transparent part which is opposite said light source and having an optical axis coincident with said axis of symmetry; and
a means for processing the images acquired by said camera.

Other features, details and advantages of the invention will become apparent on reading the description given with reference to the appended drawings, in which:

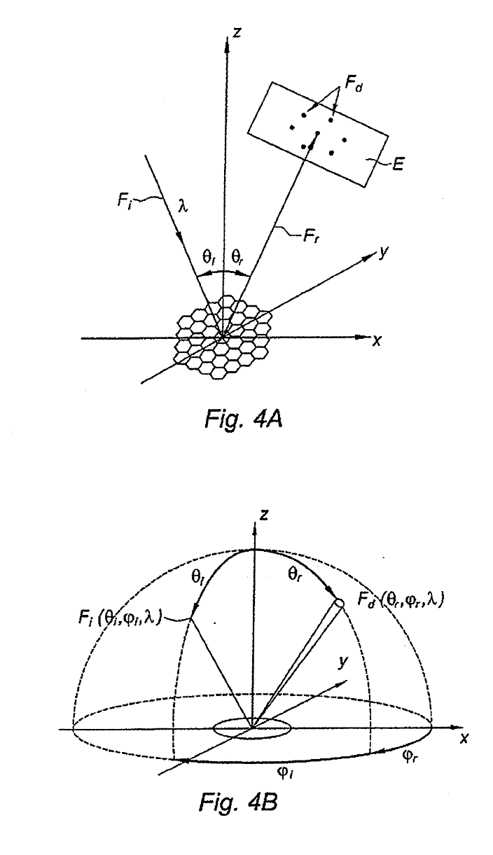

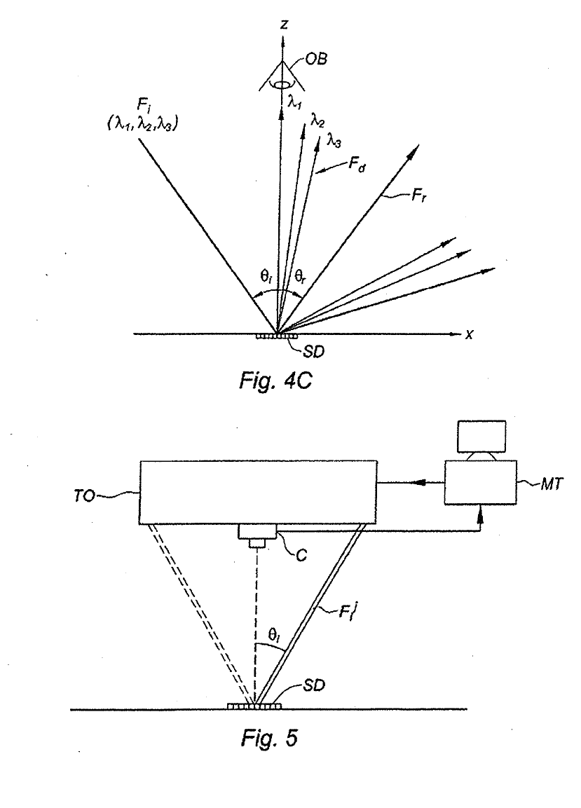

FIGS. 4A-4C illustrate the effect of diffraction by a structure able to be characterized according to the invention;

FIG. 5 illustrates, generally, an apparatus for characterizing a diffracting structure according to one embodiment of the invention;

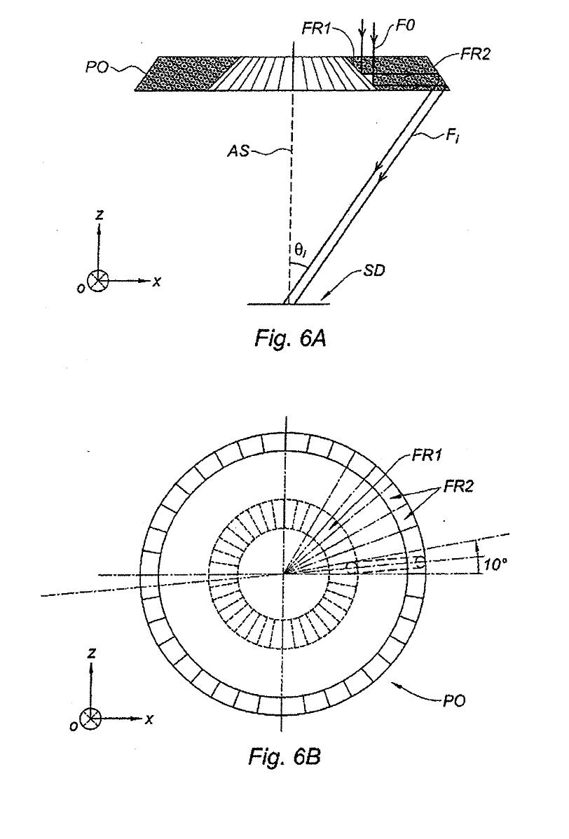

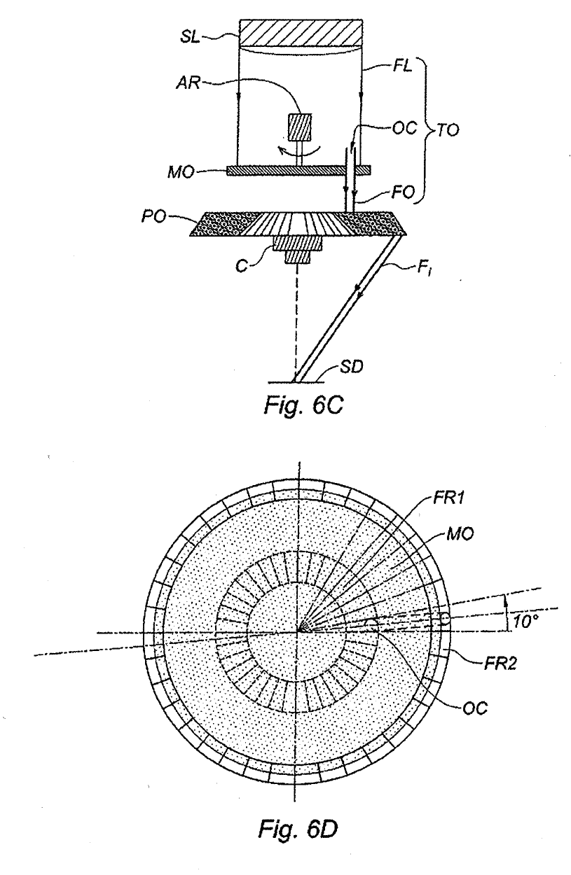

FIGS. 6A-6D show an optical head of such an apparatus; and

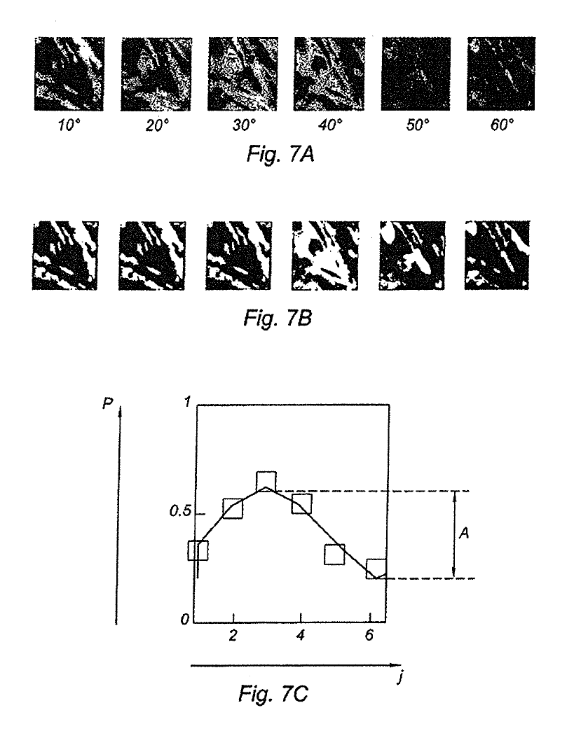

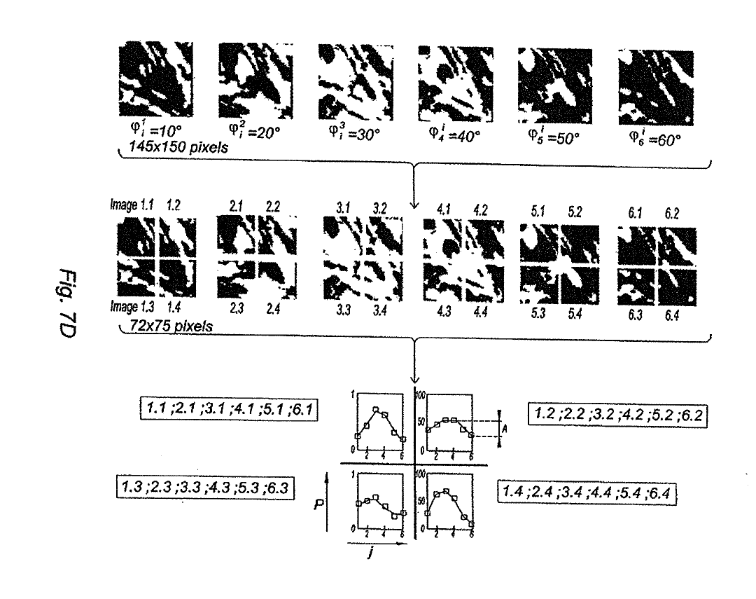

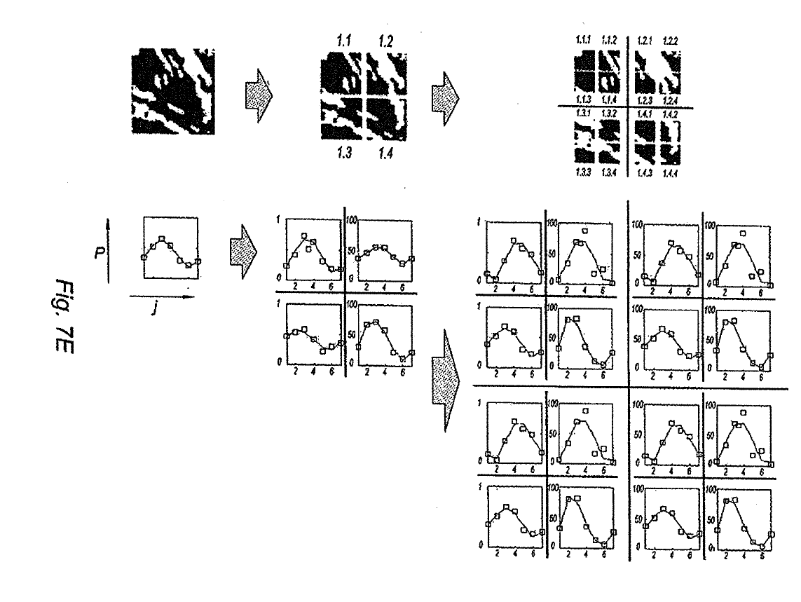

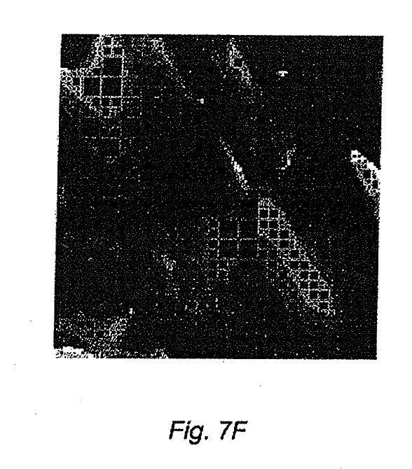

FIGS. 7A-7F illustrate an image-processing algorithm allowing a diffracting structure to be characterized according to one embodiment of the invention.

When an incident light beam Fi of wavelength A illuminates a periodic structure such as a film of particles, the light beam is diffracted into a plurality of orders (diffracted beams Fd) the number of which depends on the number of periods that the structure comprises. In the case of a structure having hexagonal symmetry (case of a film of particles arranged to form compact hexagonal assemblies), for example, diffraction of the first order occurs in 6 spatial directions, forming a hexagonal pattern on a screen E placed normal to the reflected beam (see FIG. 4A). This pattern corresponds to the Fourier transform of the image of the periodic structure.

When a periodic structure of this type is illuminated with a polychromatic incident beam (comprising a plurality of wavelengths), each wavelength is diffracted in a spatial direction that is specific thereto. The following formulae give the orientation of the diffracted beams Fd relative to the incident beam Fi:

$${θ}_{r} = arcsin [ \frac{\sqrt{{( m λ - d sin {θ}_{i} cos {ϕ}_{i} )}^{2} + {( n λ - d sin {θ}_{i} sin {ϕ}_{i} )}^{2}}}{d} ]$$

$${ϕ}_{r} = arctan [ \frac{- d sin {θ}_{i} sin {ϕ}_{i} + λ n}{- d sin {θ}_{i} cos {ϕ}_{i} + λ m} ]$$

where λ is the wavelength in question (nm);
d the lattice parameter, i.e. the distance between the centers of two particles of the film (nm);
(θᵢ, φᵢ) the inclination of the incident beam to the normal to the diffracting film and its azimuthal angle, respectively (see FIG. 4B);
(θᵣ, φᵣ) the angles defining the direction of the diffracted beam (see FIG. 4B); and
(n,m) integers defining the diffraction spots, order and position. The diffraction spots are defined for the 1st order by (n,m)=(1,1), (−1,−1), (0,1), (0,−1), (1,0), (−1,0); for the 2nd order (n,m)=(2,2) . . . (and so on, just like for the spots of the first order but replacing the “1's” with “2's”).

When a diffracting surface SD is illuminated with a polychromatic beam (wavelengths λ₁, λ₂, λ₃, etc.) at an angle of incidence θᵢ, an observer OB located normal to the structure sees the wavelength at which the above equations give θᵣ=0; if none of the illuminating wavelengths meets this condition, the structure appears black to the observer. This is illustrated in FIG. 4C.

For a given lattice parameter “d”, the angle θᵢ determines the wavelength (the color) of the radiation detected by the observer OB, whereas φᵢ—azimuthal angle of the incident beam relative to the spatial orientation of the elementary crystal unit cell of the diffracting structure—determines the intensity of said detected radiation. Thus, the brightness of each grain of the diffracting structure will depend on its orientation. Thus, acquiring a plurality of images corresponding to different azimuthal angles φᵢ^{j} allows the diffracting surface to be characterized by identifying grains (structural information), their orientation (textural information) and their degree of order. This is the principle behind the present invention.

FIG. 5 schematically shows an apparatus for implementing a characterizing method according to the invention. This apparatus essentially comprises three elements:
an optical head TO capable of generating a plurality of light beams Fᵢ^{j} having the same inclination θᵢ to the normal to the diffracting surface SD to be characterized, but different azimuthal angles φᵢ^{j};
a camera C observing the surface SD (or more precisely its portion illuminated by the light beam generated by the optical head) in an observation direction perpendicular to said surface; and
a data-processing means MT processing the images acquired by the camera C in order to obtain the required structural, textural and order information, and if needs be for controlling the optical head TO. It may especially be a question of a suitably programmed conventional computer, or indeed of a dedicated electronic board.

FIGS. 6A-6C illustrate the structure and operation of an to optical head TO able to be used to implement the method of the invention.

The essential element of this optical head is a transparent part PO (FIG. 6A: cross-sectional view; FIG. 6B: top view) having an axis of symmetry AS intended to coincide with the optical axis of the camera C, and therefore to be perpendicular to the diffracting surface SD. This part, which is for example made of glass or Plexiglas or polycarbonate or polymethyl methacrylate (PMMA), comprises a first array of M reflective facets FR1 arranged about the axis AS and inclined such that their normals make an angle of about 45° to the latter, so as to form a truncated pyramid. The part also has a second array of M reflective facets FR2, arranged around said axis AS and said first array; the second array of facets may form the lateral surface of the part. The facets FR2 are inclined such that their normals make an angle of about 45° to the axis of symmetry AS, so as to form another truncated pyramid. Furthermore, each facet FR2 is placed facing a respective facet FR1. Considering a light beam F0 that propagates parallel to the axis AS, but that is shifted laterally relative to said axis, and that penetrates into the part PO via its top side, it is reflected by a facet FR1 and propagates in a radial direction relative to the axis AS until reaching a facet FR2 that reflects it downward. The beam—indicated below by Fi—then exits from the bottom side of the part (while being deviated by refraction), and propagates, at an angle θᵢ to the axis AS, in the direction of the diffracting surface SD to be characterized, which is located under the part PO.

The inclination of the facets FR2 is chosen such that the angle θᵢ has the desired value, which is generally comprised between 10° and 80°, preferably between 25° and 50°, and which may especially be 34°. It must not be forgotten to take into account the refraction of the beam when it exits the part P0.

Assuming now that the beam F0 is moved such that its point of entry into the part PO traces a circle centered on the axis AS, each time the illuminated facet FR1 changes, the azimuthal angle of the beam Fi in turn changes. Considering for example the case where each array of the part comprises M=36 facets, such that the angle made by two consecutive facets is 10°, under these conditions 36 beams Fi having azimuthal angles spaced by steps of 10° will be obtained.

The selective illumination of the facets of the optical part may be obtained in a plurality of different ways. One particularly simple solution, illustrated in FIGS. 6C and 6D, consists in placing above the optical part PO a disk-shaped optical mask MP containing a, for example circular, aperture OC located at a distance from the axis AS tailored so that it lies plumb with a facet FR1. A motor AR makes the disk rotate about the axis AS, and a light source SL illuminates it with a collimated light beam FL of sufficiently large cross section, propagating parallel to said axis. FIG. 6C shows a side view of the optical head allowing the operation thereof to be understood, whereas FIG. 6D is a top view of the optical part PO and the mask MO.

The light beam FL may be polychromatic and spatially incoherent and for example be a beam of incoherent white light. In this case, the light source SL may especially be a light-emitting diode. The use of a monochromatic source such as a laser may lead to a better analysis performance, but experiments have shown that white light leads to satisfactory results while allowing simpler and less expensive equipment to be used.

The camera C that acquires the images may be fastened to the center of the bottom surface of the part PO. It is important for the images to be acquired when a single facet FR1 and a single facet FR2 are illuminated, and not during the transitions.

A diffracting surface of hexagonal structure must, in order to be satisfactorily characterized, be illuminated at a plurality of angles of incidence over a period of 60°. It has been verified that it is enough to acquire 6 images with six light beams having azimuthal angles φᵢ^{j}=10°=10°, 20°, 30°, 40°, 50°, 60°; more generally, N beams with φᵢ^{j}=φ₀+j·(60°/N), φ₀ being a constant, will possibly be used. N must in general be higher than or equal to 3, and preferably higher than or equal to 6. As a general rule, the higher the value of N the more precise the characterization of the surface but the longer the processing and acquisition time. Generally, it therefore does not seem to be advantageous to make N higher than 12 or even 24.

In operation, i.e. when the illumination is turning around the zone of the surface in question, the processing means is continuously processing at least 6 images taken consecutively and stored in a FIFO (First In, First Out) stack. In other words, once a block of 6 images has been analyzed, image No 1 is erased, the numbers of the remaining images are decremented by 1 and a new image having the number 6 in the image file is considered. The analysis is carried out each time the stack is updated.

FIG. 7A shows the six images stored in the stack, corresponding to azimuthal angles of illumination φᵢ^{j}=j·10°=10°, 20°, 30°, 40°, 50°, 60°. The images shown here are grayscale images, but they may also be color images and show an iridescence effect.

The first step of the processing consists in thresholding the images in the stack in order to obtain a black-and-white image, the white pixels corresponding to bright zones of the image (high light intensity) and the black pixels corresponding to zones of low light intensity (FIG. 7B).

The second step of the processing consists in calculating the proportion P of white pixels in each image (P=1: completely white image; P=0: completely black image). These values are represented in FIG. 7C in the form of a curve (x-axis: number j of the image; y-axis: corresponding P value). Next, the difference A between the highest value and the lowest value of P in the group of six images is calculated. As a variant, P could be defined as the proportion of black pixels.

If A is higher than a threshold Aₘₐₓ, generally of about 0.9, the observed diffracting surface is considered to have an order of high quality, and the analysis may terminate. If A is lower than a threshold Aₘᵢₙ, generally of about 0.2, the observed diffracting surface is considered to be disordered (amorphous), and the analysis may terminate. If A is comprised between Aₘᵢₙ and Aₘₐₓ, this means that a plurality of grains are being observed at the same time; the analysis must continue to identify these grains and any amorphous regions also present. In this case, as illustrated in FIG. 7D, each image is divided into four smaller images (“imagettes”) taking the form of quadrants, corresponding to respective regions of the surface. The six imagettes corresponding to a given region of the surface are grouped, their proportions P are determined, then the difference A of each group is determined. The analysis continues in this way recursively by successive subdivision of images associated with regions characterized by intermediate values of A (FIG. 7E) until a stop criteria is met (in the limit, until each imagette consists of a single pixel; in practice, it does not seem very relevant to drop below a zone of 8×8 pixels).

In addition, for high or intermediate values of A, that image from the six which contains the most white pixels indicates the privileged illumination angle provoking the maximum diffraction of the observed film of particles. With each observed image or imagette, it is thus possible to associate a privileged angular orientation of the incident beam and therefore to determine the orientation of the hexagonal patterns located in the corresponding region of the surface. This is information on the texture of the film.

Step 4: On the basis of the processing protocol described above, it is possible to reconstruct an image formed of squares of different sizes depending on the number of subdivisions (FIG. 7F). In this case it is a question of an artifact that could be removed by fusing the square zones corresponding to a given crystal orientation.

The squares forming the image belong to one of the following three categories:
perfect or almost perfect crystal: A>Aₘₐₓ;
Crystal of average quality: Aₘᵢₙ≦A≦Aₘₐₓ;
Absence of crystalline organization or a crystalline organization that is very poor and indiscernible on the macroscopic scale: A<Aₘᵢₙ.

This analysis makes it possible in the end to determine:

1) The structure of the film of particles by considering the squares for which A<Aₘᵢₙ, which correspond to amorphous zones or to grain boundaries;

2) the texture of the film of particles by considering, for each square for which Aₘᵢₙ≦A, the privileged orientation of the incident beam; and

3) the degree of order of the film of observed particles. This degree is a quality indicator calculated with the following expression: degree of order ORD=1−(S_{NC}/S_{TOT}), where S_{NC} is the area of the regions of said surface to which a value A≦Aₘᵢₙ has been attributed and S_{TOT} is the total area of the observed portion of the surface.

In a conventional way, image-processing steps aiming to improve or optimize the quality of the images will possibly be associated with the protocol described above. These steps will for example aim to decrease illumination drift in order to increase the reliability of the analysis.

A plurality of variants of the protocol may be envisioned. For example, each image may be subdivided into a number other than four of images of smaller size. In the case of a subdivision into four quadrants, as in the above example, it is advantageous for the initial image to be square and comprise a number of rows and columns given by a power of two.

The method of the invention is particularly suitable for monitoring in real time a process for manufacturing regular assemblies of nano- and micro-particles such as the process described in document WO2012113745. Specifically, the optical head may be easily integrated into an apparatus for implementing such a process; furthermore, a sufficiently large area of diffracting surface (of 1 cm² or more) may be characterized. However, this is not a limitation, and the invention may be suitable for many other applications.

1. A method for characterizing a diffracting surface having a grain structure, comprising steps:
a) illuminating in succession said surface with a plurality of light beams (Fij) having propagation directions inclined at the same angle θᵢ to the normal to the surface and the projections of which onto the surface make different azimuthal angles φᵢ^{j} to a reference direction;
b) acquiring a two-dimensional image of said surface in correspondence with each of said light beams; and
c) digitally processing said two-dimensional images to obtain at least one piece of information on at least one property of said surface, chosen from: its grain structure, its texture and its degree of order.

2. The method as claimed in claim 1, in which each of said grains has a two-dimensional periodicity with hexagonal symmetry and in which said azimuthal angles φᵢ^{j} are given by: φᵢ^{j}=φ₀+j·(60°/N), where N is the number of beams, the index j ranges from 1 to N and φ₀ is a constant.

3. The method as claimed in claim 1, in which the number N of light rays used is higher than or equal to 3.

4. The method as claimed in claim 1, in which, in said step b), said images are acquired in an observation direction normal to the surface to be characterized.

5. The method as claimed in claim 1, in which said step c) comprises the substeps consisting in:
c1) thresholding each of said images in order to attribute to each of its pixels a binary value indicative of a light intensity respectively higher than or lower than a set threshold;
c2) for each image having undergone said thresholding, calculating a proportion P of pixels having the same said binary value;
c3) determining the difference A between the highest value and the lowest value of the proportions P for said images; and
c4) if the value of A is comprised between a first threshold Aₘᵢₙ and a second threshold Aₘₐₓ, and if a stop condition is not met, subdividing each image into a plurality of smaller images corresponding to respective regions of the surface to be characterized, grouping the n smaller images corresponding to each of said regions and repeating the substeps c1) to c4) for each group thus obtained;
whereby a value A is attributed to the surface or to each of said regions of the surface.

6. The method as claimed in claim 5, in which said proportion P of pixels having the same binary light intensity value is expressed by a number comprised between 0 and 1, said first threshold Aₘᵢₙ is comprised between 0.1 and 0.4, and said second threshold Aₘₐₓ is comprised between 0.6 and 0.95.

7. The method as claimed in claim 5, in which, in said substep c4), each image is subdivided into four smaller images taking the form of quadrants.

8. The method as claimed in claim 7, in which said image is formed by a square matrix of pixels having a number of rows and columns that is a power of two.

9. The method as claimed in claim 5, also comprising a step d) implemented after said step c) and consisting in identifying as crystal grains (G₁, G₂) zones of the surface to be characterized formed by contiguous regions associated with subimages to which a value A>Aₘᵢₙ has been attributed and separated by contiguous regions associated with subimages to which a value A<Aₘᵢₙ has been attributed.

10. The method as claimed in claim 5, also comprising a step e) implemented after said step c) and consisting in determining information on the texture of at least one of said regions of the surface to be characterized to which a value A>Aₘᵢₙ has been attributed, said step e) being implemented by identifying the azimuthal angle φᵢ^{j} to which corresponds the highest proportion of pixels having a light intensity higher than said set threshold.

11. The method as claimed in claim 5, also comprising a step f) implemented after said step c) and consisting in determining a degree of order ORD of the surface to be characterized by applying the formula ORD=1−(S_{NC}/S_{TOT}), where S_{NC} is the area of the regions of said surface to which a value A≦Aₘᵢₙ has been attributed and S_{TOT} is the total area of the observed portion of the surface.

12. The method as claimed in claim 1, in which said surface to be characterized is formed by an assembly of particles of nanoscale or micron-size dimensions on a substrate.

13. The application of a method as claimed in claim 12 to the monitoring of a process for manufacturing an assembly of particles of nanoscale or micron-size dimensions on a substrate.

14. An optical head for implementing a method as claimed in claim 1, comprising:
a transparent part (PO) having an axis of symmetry and comprising: a first array of M reflective facets arranged around said axis and the normals of which make an angle of about 45° to the latter; and a second array of M reflective facets arranged around said axis and said first array and the normals of which make the same angle larger than 45° to said axis, each facet of said second array being placed facing a respective facet of said first array; and
a means for selectively illuminating each facet of said first array with a light beam propagating in a direction parallel to said axis of symmetry.

15. The optical head as claimed in claim 14, in which said means for selectively illuminating each facet of said first array with a light beam propagating in a direction parallel to said axis of symmetry comprises:
a light source, for directing toward said part a light beam propagating parallel to said axis of symmetry;
an optical mask interposed between said light source and said part, said mask being mounted so as to be rotatable about said axis of symmetry and comprising an aperture in correspondence with a facet of said first array; and
an actuator for making said optical mask rotate about said axis of symmetry.

16. An apparatus for implementing a method as claimed in claim 1, comprising:
an optical head comprising:
a transparent part having an axis of symmetry and comprising: a first array of M reflective facets arranged around said axis and the normals of which make an angle of about 45° to the latter; and a second array of M reflective facets (arranged around said axis and said first array and the normals of which make the same angle larger than 45° to said axis, each facet of said second array being placed facing a respective facet of said first array; and
a means for selectively illuminating each facet of said first array with a light beam propagating in a direction parallel to said axis of symmetry;
a camera mounted on that side of said transparent part which is opposite said light source and having an optical axis coincident with said axis of symmetry; and
a means for processing the images acquired by said camera.
